(19) United States
(12) Patent Application Publication
(10) Pub. No.: US 2009/0106672 A1
(43) Pub. Date: Apr. 23, 2009

(54) VIRTUAL WORLD AVATAR ACTIVITY GOVERNED BY PERSON'S REAL LIFE ACTIVITY

(75) Inventor: David Per BURSTROM, Lund (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 11/923,867

(22) Filed: Oct. 25, 2007

Related U.S. Application Data
(60) Provisional application No. 60/980,814, filed on Oct. 18, 2007.

(51) Int. Cl. H04Q 7/20; G06F 15/00

(52) U.S. Cl. 715/757; 455/456.3

(57) ABSTRACT

A system generates a virtual world and generates a first avatar, which is associated with a person, in the virtual world. The system further receives data associated with the person's mobile wireless device, where the data includes a location of the mobile wireless device. The system determines the person's real world activities based on the data and causes the person's first avatar to engage in the same, similar, or analogous activities, as the determined real world activities, in the virtual world.

### CROSS REFERENCE TO RELATED APPLICATION

The instant application claims priority from provisional application No. 60/980,814, filed Oct. 18, 2007, the disclosure of which is incorporated by reference herein in its entirety.

### TECHNICAL FIELD OF THE INVENTION

Implementations described herein relate generally to computer-based simulated environments and, more particularly, to using a person's real world activity to govern activities associated with that person's avatar in a computer-based simulated environment.

### BACKGROUND

Virtual worlds are computer-based simulated environments that are intended for participants to inhabit and interact with via avatars. The avatars in the virtual world typically represent the participants as two or three dimensional graphical representations of humanoids. The world being computer-simulated typically appears similar to the real world, with real world rules such as gravity, topography, locomotion, real-time actions and communication. One type of virtual world includes an online persistent world that is active and available 24 hours a day, seven days a week. Virtual worlds may include on-line role playing games, where each participant plays a specific character, or on-line real-life/rogue-like games where each participant can edit and alter their avatar at will.

### SUMMARY

According to one aspect, a computer-implemented method may include generating a virtual world; generating a first avatar, that is associated with a person, in the virtual world; receiving first data associated with the person's mobile wireless device, where the first data comprises a location of the mobile wireless device; determining the person's real world activities based on the first data; and causing the person's first avatar to engage in the same, similar, or analogous activities, as the determined real world activities, in the virtual world.

Additionally, the computer-implemented method may include receiving second data associated with the person, where the second data relates to light conditions or ambient noise of an environment at which the person is located or a motion associated with the person and determining the person's real world activities further based on the second data

Additionally, determining the person's real world activities may further include deducing the person's real world activities based on the first data.

Additionally, the data may further include a communication status associated with the mobile wireless device.

Additionally, the communication status may include whether the person is communicating with an other person using the mobile wireless device.

Additionally, the computer-implemented method may further include generating a second avatar associated with the other person in the virtual world; and causing the other person's second avatar to interact with the first avatar in the virtual world based on the communication status.

Additionally, the person may be communicating with the other person via an audio phone call.

Additionally, the person may be communicating with the other person via instant messaging.

Additionally, the person may be communicating with the other person via email.

Additionally, the person may be communicating with the other person via text messaging.

According to another aspect, a system may include a network interface configured to receive data associated with a person's mobile wireless device, where the data comprises a location of the mobile wireless device. The system may further include one or more processing units configured to generate a virtual world, deduce the person's real world activities based on the data, and cause an avatar associated with the person to engage in the same, similar, or analogous activities, as the deduced real world activities, in the virtual world.

Additionally, the data may further include a communication status associated with the mobile wireless device.

Additionally, the communication status may include whether the person is communicating with an other person using the mobile wireless device.

Additionally, the one or more processing units may be further configured to generate a second avatar associated with the other person in the virtual world, and cause the other person's second avatar to interact with the first avatar in the virtual world based on the communication status.

Additionally, the person may be communicating with the other person via an audio phone call.

Additionally, the person may be communicating with the other person via instant messaging.

Additionally, the person may be communicating with the other person via email.

Additionally, the person may be communicating with the other person via text messaging.

According to a further aspect, a computer-readable medium containing instructions executable by at least one processor may include one or more instructions for generating a virtual world; one or more instructions for receiving data associated with a location of a person's mobile wireless device; and one or more instructions for automatically engaging a first avatar associated with the person in activities in the virtual world based on the data.

Additionally, the data may further include a communication status associated with the mobile wireless device.

Additionally, the communication status may further include whether the person is communicating with an other person using the mobile wireless device.

Additionally, the computer-readable medium may further include one or more instructions for automatically engaging a second avatar associated with the other person in activities in the virtual world based on the communication status.

According to an additional aspect, a computer system may include means for generating a virtual world; means for receiving data associated with a person's mobile wireless device, where the data comprises a location of the mobile wireless device and a communication status associated with the mobile wireless device; means for determining the person's real world activities based on the data; and means for causing an avatar associated with the person to engage in the same, similar, or analogous activities, as the determined real world activities, in the virtual world.

It should be emphasized that the term “comprises/comprising” when used in this specification is taken to specify the presence of stated features, integers, steps, components or groups but does not preclude the presence or addition of one or more other features, integers, steps, components or groups thereof.

### BRIEF DESCRIPTION OF THE DRAWINGS

The accompanying drawings, which are incorporated in and constitute a part of this specification, illustrate one or more embodiments of the invention and, together with the description, explain the invention. In the drawings,

FIG. 1 illustrates an overview of an exemplary embodiment in which actions associated with one or more persons who carry and/or use mobile wireless devices may be used to govern corresponding actions of those person's avatars in a virtual world;

FIG. 2A illustrates a network in which exemplary embodiments may be implemented;

FIG. 2B illustrates the use of activities associated with one or more persons who carry and/or use mobile wireless devices in the network of FIG. 2A to govern corresponding actions of those person's avatars in a virtual world;

FIG. 3 illustrates an exemplary architecture of a device, which may correspond to the mobile wireless device, activity tracker, virtual world server, or clients of FIG. 2A;

FIG. 4 is a flowchart of an exemplary process for governing persons' virtual world avatar activity based on the persons' activities in the real world; and

FIGS. 5-9 depict different examples of the activity of a person's avatar in a virtual world being governed by the activity of the person in the real world.

### DETAILED DESCRIPTION OF EMBODIMENTS

The following detailed description of the invention refers to the accompanying drawings. The same reference numbers in different drawings may identify the same or similar elements. Also, the following detailed description does not limit the invention.

Exemplary embodiments described herein use data associated with real world activities of persons to govern the activities of those persons' avatars in a virtual world. The real world activities of the persons may be determined by analyzing data associated with carrying and/or using a mobile wireless device by each person. The data associated with carrying and/or using the mobile wireless device may include a geo-location of the device (e.g., indicating movement of the person) and/or a communication status of the device (e.g., indicating whether the device is being used to make a phone call or to send email, instant messages or text messages). Determining the real world activities of the persons may include inferring or deducing the persons' real world activities based on the data associated with carrying and/or using the mobile wireless devices such that the activities of the persons' avatars in the virtual world may only approximate the real world activities of the persons in the real world. In other embodiments, the real world activities associated with the persons may be determined by data other than (or in addition to) data associated with carrying and/or using the mobile wireless device. For example, environmental conditions, such as, for example, light conditions or ambient noise, associated with the persons may be used for determining the real world activities of the persons. As another example, accelerometer or speedometer data associated with movement or motion of the persons may be used for determining the real world activities of the persons.

### Overview

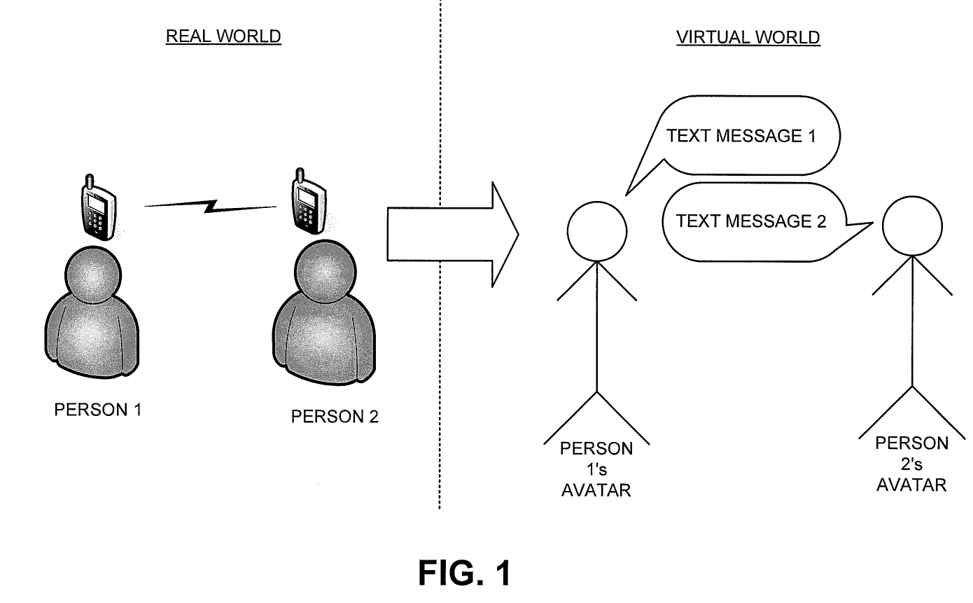

FIG. 1 is a diagram of an overview of an exemplary embodiment in which actions associated with one or more persons who carry and/or use mobile wireless devices may be used to govern corresponding actions of those person's avatars in a virtual world. A “virtual world” as the term is used herein is to be broadly interpreted to include any computer-based simulated environment intended for its users to inhabit and interact via “avatars.” This habitation typically is represented in the form of two or three-dimensional graphical representations of humanoids (or other graphical or text-based avatars). The virtual world being computer-simulated typically appears similar to the real world, with real world rules such as gravity, topography, location, real-time actions, and communication. Communication in the virtual world may include textual communication or, possibly, voice communication (e.g., using voice over Internet Protocol (VOIP)). “Avatar” as the term is used herein is to be broadly interpreted to include a graphical or textual representation of a person that can be selected from a group of choices, or created by the person, to represent that person in the virtual world. An avatar can be a simple two-dimensional image or graphical construct, or a more complex three-dimensional image or graphical construct, which may have a textual component associated with it. In some implementations, a virtual world may include an on-line persistent world that is active and available 24 hours a day and seven days a week. Examples of virtual worlds include The Sims On-line, Spore, Second Life, Playstation Home, MTV's Virtual Worlds, There.com, Whyville, ViOS, Active Worlds, Entropia Universe, Red Light Center, Kaneva, Weblo, Everquest, Ultima Online, Lineage, World of Warcraft or Guild Wars. A “virtual world” as described herein may be a virtual representation of our world today, or could be a stone age, medieval, renaissance, western, or futuristic representation of our world.

FIG. 1 illustrates one exemplary implementation in which the real world actions associated with two people who use mobile wireless devices to communicate with one another governs their respective avatars in a virtual world. As shown, a first person (person 1) communications with another person (person 2) using text messaging via mobile wireless devices. In the virtual world of which both persons are members, an avatar associated with person 1 is graphically shown as communicating with an avatar associated with person 2. As shown in FIG. 1, the communication between person 1's and person 2's avatars may include dialog balloons that depict the content of the textual messages sent between the two. FIG. 1 depicts only one exemplary embodiment in which real world actions associated with people who carry and/or use mobile wireless devices govern the actions of the people's respective avatars in a virtual world. Additional exemplary embodiments are further described below.

### Exemplary Network

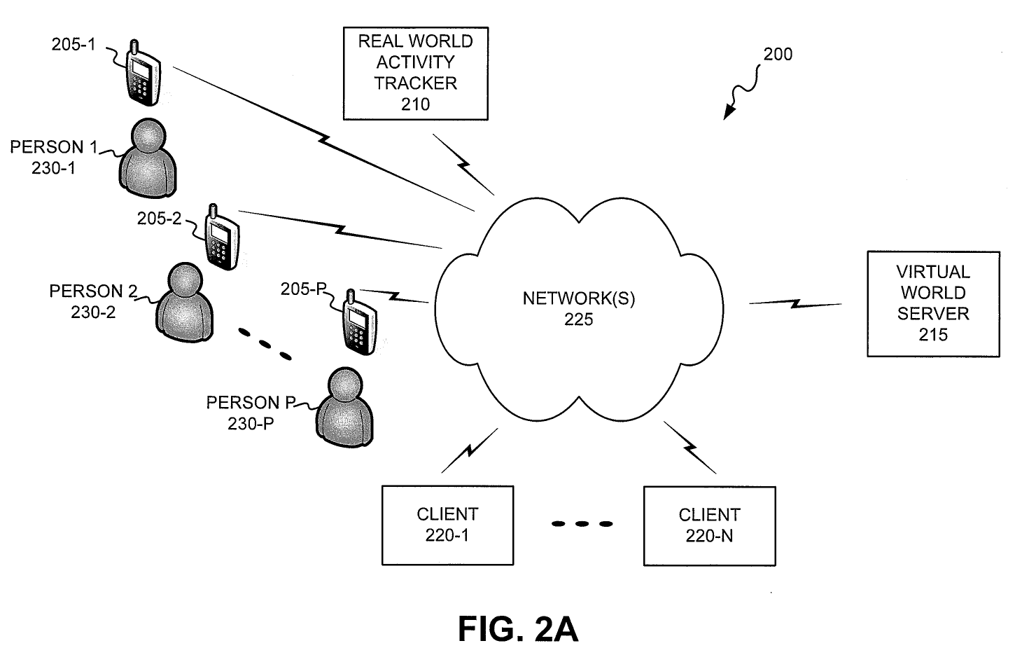

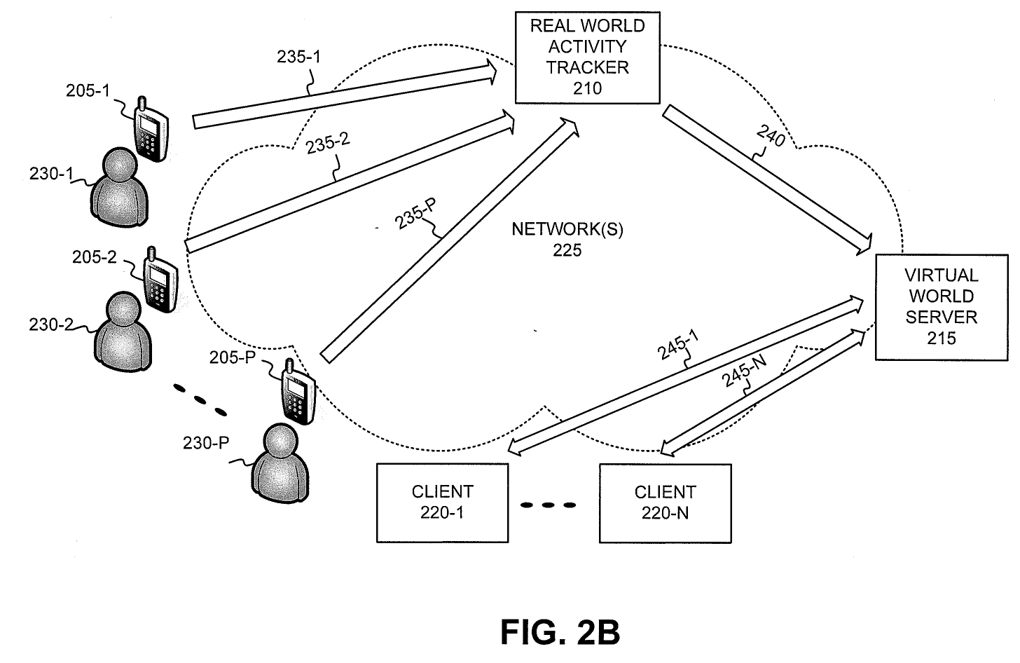

FIG. 2A illustrates a network 200 according to an exemplary embodiment. Network 200 may include multiple wireless devices 205-1 through 205-P, a real world activity tracker 210, a virtual world server 215 and one or more clients 220-1 through 220-N, connected to one or more sub-networks 225. Mobile wireless devices 205-1 through 205-P may connect to the one or more sub-networks 225 via wireless links (e.g., radio-frequency or free-space optical links). Real world activity tracker 210, virtual world server 215 and clients 220-1 through 220-N may connect to the one or more sub-networks 225 via wired or wireless links. Persons 230-1 through 230-P may carry and/or use respective mobile wireless devices 205-1 through 205-P.

Mobile wireless devices 205-1 through 205-P may include cellular radiotelephones, personal digital assistants (PDAs), Personal Communications Systems (PCS) terminals, laptop computers, palmtop computers, or any other type of appliance that includes a communication transceiver that permits the devices, and the people who use and carry them, to be mobile. Real world activity tracker 210 may receive data from mobile wireless devices 205-1 through 205-P. The data may be associated with the activities of respective persons 230-1 through 230-P. Such activities may include, but are not limited to, a current geo-location of a mobile wireless device 205-x (e.g., indicating geographic movement of the respective person 230-x) or a communication status of mobile wireless device 205-x.

Virtual world server 215 may implement an on-line virtual world that may be accessed by clients 220-1 through 220-N. Users associated with clients 220-1 through 220-N may, via network(s) 225, access the virtual world implemented at virtual world server 215. In other implementations, portions of, or the entirety of, the virtual world may be implemented by a client application hosted at a client 220-x, instead of virtual world server 215. Real world activity tracker 210 and virtual world server 215 are shown as separate entities in FIG. 2A. In some implementations, however, activity tracker 210 and virtual world server 215 may be implemented as a single network entity, or portions of the functionality of activity tracker 210 may be performed by virtual world server 215, or vice versa.

Clients 220-1 through 220-N may each reside on a device, such as, for example, a desktop, laptop or palmtop computer, a PDA, a cellular radiotelephone, or other type of computation device that may connect to virtual world server 215 via network(s) 225. In some instances, one or more of clients 220-1 through 220-N may reside on mobile wireless devices 205-1 through 205-P.

Sub-network(s) 225 may include one or more networks of any type, including a local area network (LAN); a wide area network (WAN); a metropolitan area network (MAN); a telephone network, such as the Public Switched Telephone Network (PSTN) or a Public Land Mobile Network (PLMN); an intranet, the Internet; or a combination of networks. The PLMN(s) may further include a packet-switched sub-network, such as, for example, General Packet Radio Service (GPRS), Cellular Digital Packet Data (CDPD), or Mobile IP sub-network.

FIG. 2B graphically depicts the use of activities associated with one or more persons who carry and/or use mobile wireless devices in network 200 to govern corresponding activities of those person's avatars in a virtual world. As shown in FIG. 2B, data 235-1 through 235-P associated with respective persons' 230-1 through 230-P real world actions are provided to real world activity tracker 210. Real world activity tracker 210 may, in some implementations, further analyze the data 235-1 through 235-P to determine, or deduce, the persons 230-1 through 230-P respective real world activities at any given moment in time. The results of the analysis may be provided as an input 240 to virtual world server 215. In other implementations, virtual world tracker 215 may analyze the data 235-1 through 235-P to determine or deduce the persons' 230-1 through 230-P real world activities. In such implementations, the data 235-1 through 235-P may be forwarded from activity tracker 210 to virtual world server 215. Upon receiving the input 240, virtual world server 215 may control the actions of the avatars associated with persons 230-1 through 230-P to be the same, similar to, or analogous to the persons 230-1 through 230-P real world activities.

Clients 220-1 through 220-N may access, e.g., via connections 245-1 through 245-N, the virtual world implemented at real world server 215 such that the actions of the avatars associated with persons 230-1 through 230-P may be observed.

### Exemplary Device Architecture

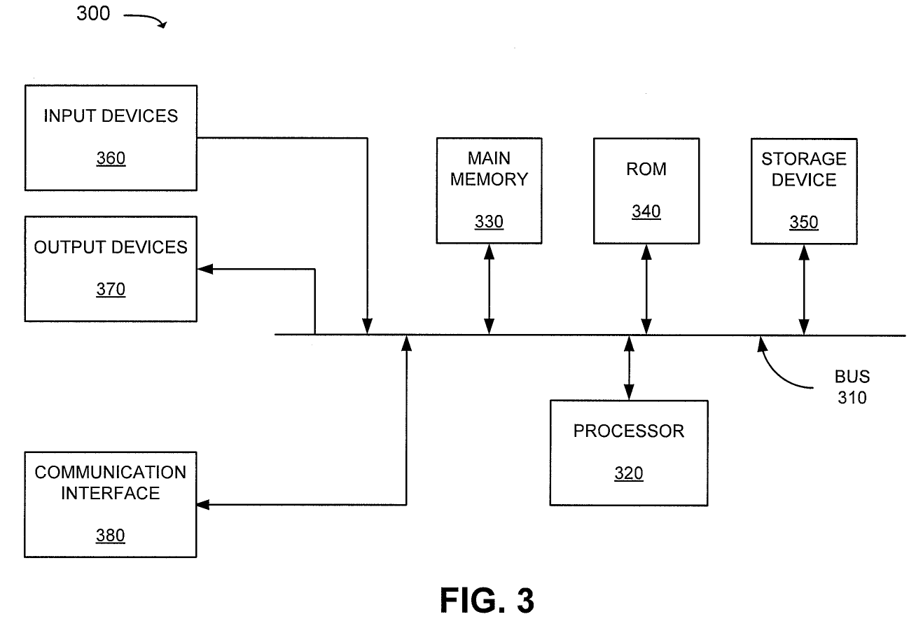

FIG. 3 is an exemplary diagram of an architecture of a device 300, which may correspond to each of mobile wireless devices 205-1 through 205-P, real world activity tracker 210, virtual world server 215, and/or clients 220-1 through 220-N. Device 300 may include a bus 310, a processor 320, a main memory 330, a read only memory (ROM) 340, a storage device 350, an input device 360, an output device 370, and a communication interface 380. Bus 310 may include a path that permits communication among the elements of device 300.

Processor 320 may include a processor, microprocessor, or processing logic that may interpret and execute instructions. Main memory 330 may include a random access memory (RAM) or another type of dynamic storage device that may store information and instructions for execution by processor 320. ROM 340 may include a ROM device or another type of static storage device that may store static information and instructions for use by processor 320. Storage device 350 may include a magnetic and/or optical recording medium and its corresponding drive.

Input device 360 may include a mechanism that permits an operator to input information to device 300, such as a keyboard, a mouse, a pen, a touch screen, voice recognition and/or biometric mechanisms, etc. Output device 370 may include a mechanism that outputs information to the operator, including a display, a printer, a speaker, etc. Communication interface 380 may include any transceiver-like mechanism that enables device 300 to communicate with other devices and/or systems. For example, communication interface 380 may include mechanisms for communicating with another device or system via a network, such as sub-network 225. In implementations in which device 300 communicates via a radio-frequency (RF) link, communication interface 380 may include a radio-frequency (RF) transceiver. In implementations in which device 300 communicates via a free-space optical link, communication interface 380 may include an optical transceiver.

Device 300, consistent with exemplary implementations, may perform certain processes, as will be described in detail below. Device 300 may perform these processes in response to processor 320 executing software instructions contained in a computer-readable medium, such as memory 330. A computer-readable medium may include a physical or logical memory device.

The software instructions may be read into memory 330 from another computer-readable medium, such as data storage device 350, or from another device via communication interface 380. The software instructions contained in memory 330 may cause processor 320 to perform processes that will be described later. Alternatively, hardwired circuitry may be used in place of or in combination with software instructions to implement processes consistent with exemplary implementations. Thus, implementations are not limited to any specific combination of hardware circuitry and software.

### Exemplary Process

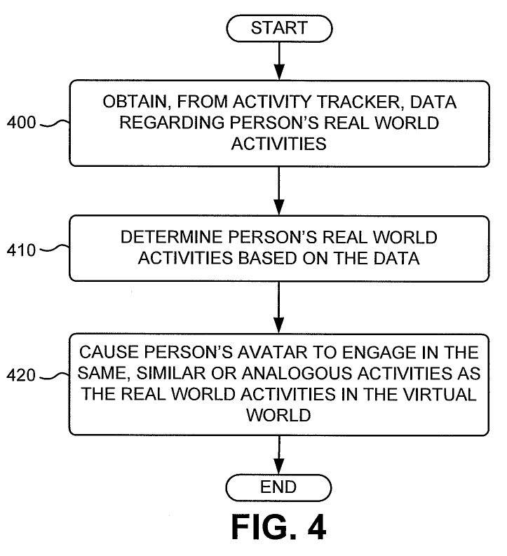

FIG. 4 is a flowchart of an exemplary process for governing persons' virtual world avatar activity based on those persons' activities in the real world. The process exemplified by FIG. 4 may be performed by virtual world server 215. In one exemplary embodiment, the exemplary process of FIG. 4 may be implemented as a set of instructions stored in main memory 330 and executed by processor 320. Contemporaneously with the execution of the exemplary process of FIG. 4, virtual world server 215 may implement a virtual world that may be accessed by clients 220-1 through 220-N via network(s) 225.

The exemplary process may begin with obtaining, from real world activity tracker 210, data regarding a person's real world activities (block 400). Real world activity tracker 210 may obtain data associated with the use or operation of mobile wireless devices 205-1 through 205-P. For example, real world activity tracker 210 may obtain Global Positioning System (GPS) data, or other similar geographic location data, from mobile wireless devices 205-1 through 205-P indicating their current geo-locations. As another example, real world activity tracker 210 may additionally obtain data associated with communication activities occurring at mobile wireless devices 205-1 through 205-P. Persons 230-1 through 230-P associated with mobile wireless devices 205-1 through 205-P may engage in audio phone calls with, send emails, instant messages or text messages to, other person's who have avatars in the virtual world. The data regarding the person's real world activities may be sent from real world activity tracker 210 to virtual world server 215.

The person's real world activities may be determined based on the obtained data (block 410). Virtual world server 215 may analyze the geographic movements of each person, based on the obtained data, to track if the person is traveling or staying in a same location. Virtual world server 215 may also use the geo-location coordinates of a person (e.g., GPS data) and match the coordinates with a database of establishments, such as, for example, restaurants, stores, gyms, parks, etc., to deduce the person's real world activities. For example, if the geo-location coordinates indicate that the person is located at a restaurant, it may be deduced that the person is currently dining at the restaurant. As another example, if the geo-location coordinates indicate that the person is located at cinema, it may be deduced that the person is currently watching a movie. Virtual world server 215 may additionally use the geo-location coordinates of two or more persons to determine if they are in close proximity to one another. If so, it may be deduced that the persons in close proximity to one another are communicating with one another. Furthermore, persons may be determined to be communicating with one another if they are engaged in audio phone calls or in email, instant message or text message exchanges with one another. As another example, a person may be determined to have bought a given product if the person makes an electronic purchase of the product via mobile wireless device 205-x. As a further example, a person may be determined to have taken one or more pictures if the person takes the pictures using a camera contained in mobile wireless device 205-x.

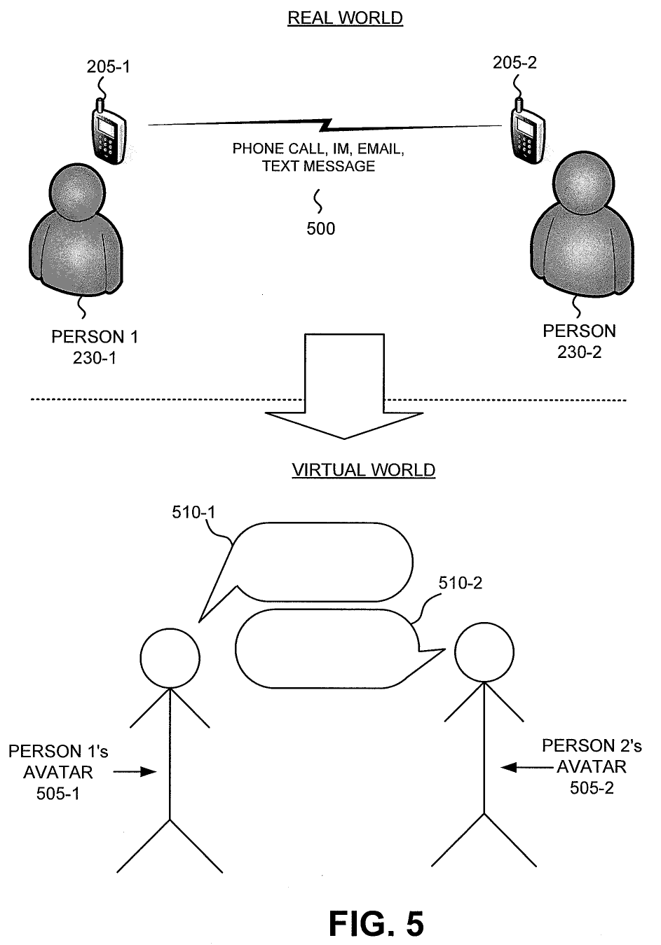

The person's avatar may be caused to engage in the same, similar or analogous activities as the real world activities in the virtual world (block 420). Virtual world server 215 may govern a person's avatar in the virtual world such that it acts similarly to the person in the real world. For example, if the person is traveling a lot in the real world, then the person's avatar may appear to be traveling a lot in the virtual world. The person's avatar may also engage in exactly the same activity as the person in the real world (e.g., a person eating at a restaurant causes the person's avatar to appear to be eating), or the person's avatar may engage in similar or analogous activities as the person in the real world. For example, if a person if often close by the sea, as determined from geo-location data, then the person's avatar may appear to take a trip on a sailing boat on a virtual sea (i.e., which might inspire the person to go sailing). FIGS. 5-9 depict a few different examples of the activity of a person's avatar in a virtual world being governed by the activity of the person in the real world.

In one example shown in FIG. 5, a first person 230-1 in the real world may use a mobile wireless device 205-1 to communicate 500 (e.g., engage in a phone call or send an instant message, an email or a text message) with a mobile wireless device 205-2 of a second person 230-2. In the virtual world, person 1's avatar 505-1 may then be displayed via, for example, a dialog balloon 510-1, as communicating with person 2's avatar 505-2 who may also be shown as communicating via a dialog balloon 510-2.

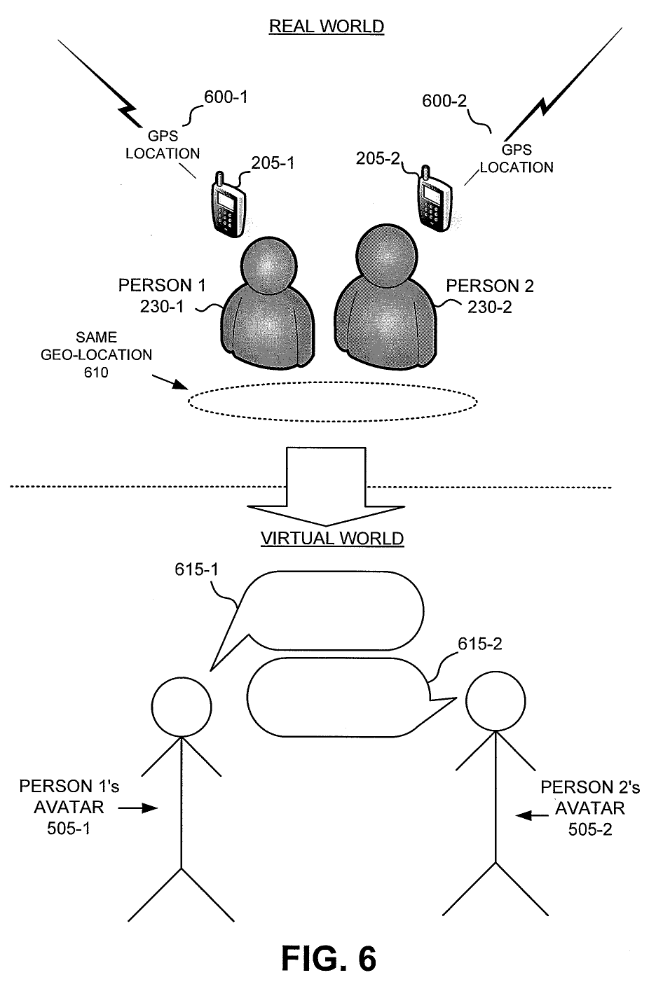

In another example shown in FIG. 6, two persons 230-1 and 230-2 in the real world may be located at a same geo-location 610 as indicated by GPS location data 600-1 and 600-2 obtained from respective mobile wireless devices 205-1 and 205-2. In the virtual world, due to their close proximity in the real world, person 1's avatar 505-1 may be displayed via, for example, a dialog balloon 615-1, as communicating with person 2's avatar 505-2 who may also be shown as communicating via a dialog balloon 615-2.

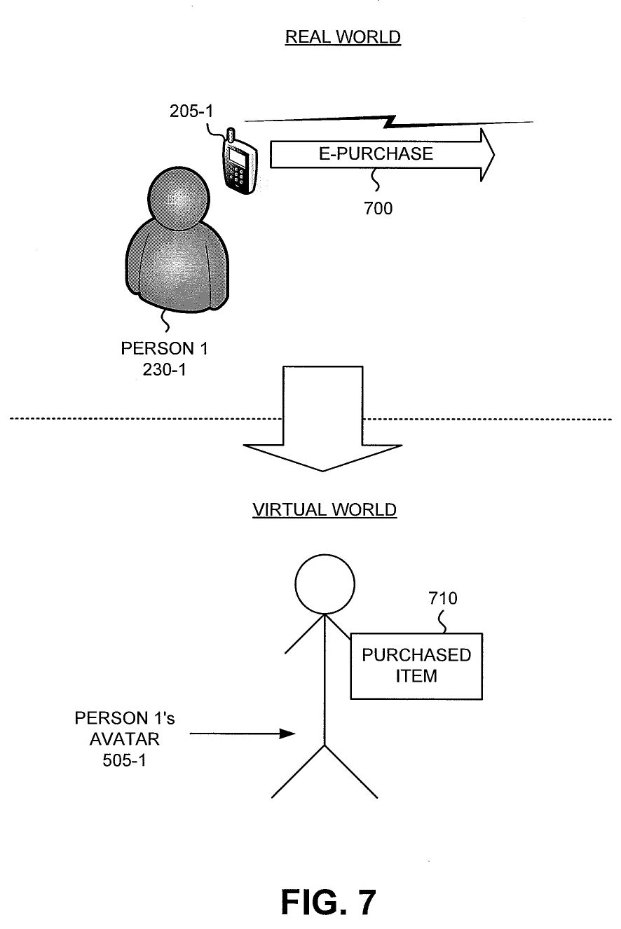

In a further example shown in FIG. 7, a person 230-1 may use a mobile wireless device 205-1 to make an electronic purchase 700 in the real world. In the virtual world, the person's avatar 505-1 may be displayed as holding or carrying an item 710 that was purchased electronically.

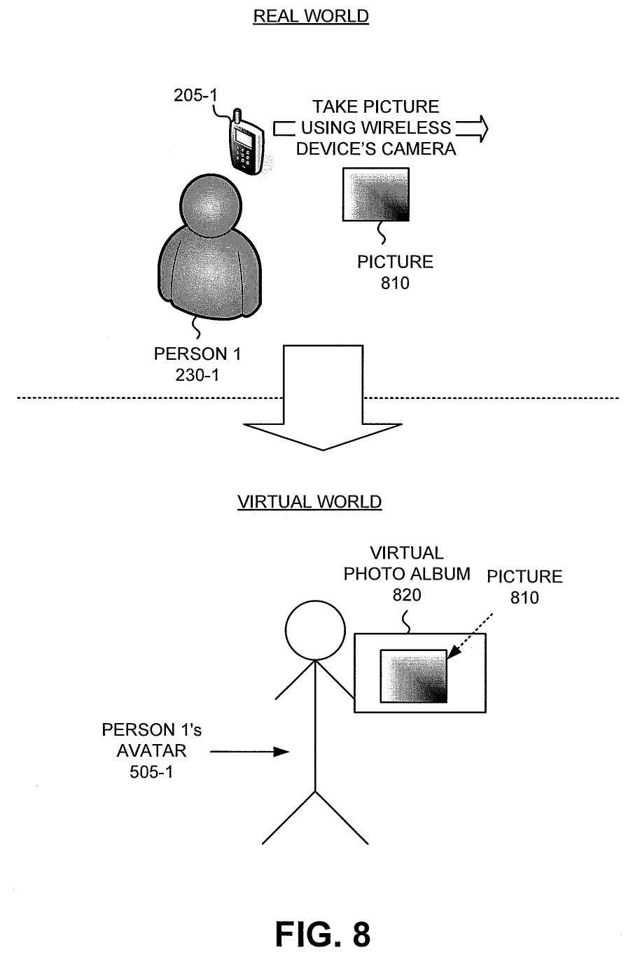

FIG. 8 depicts an additional example, where a person 230-1 uses a camera contained in mobile wireless device 205-1 to take a picture 810 in the real world. In the virtual world, the person's avatar 505-1 may be shown in association with a virtual photo album 820 that depicts the picture 810 taken by the user in the real world.

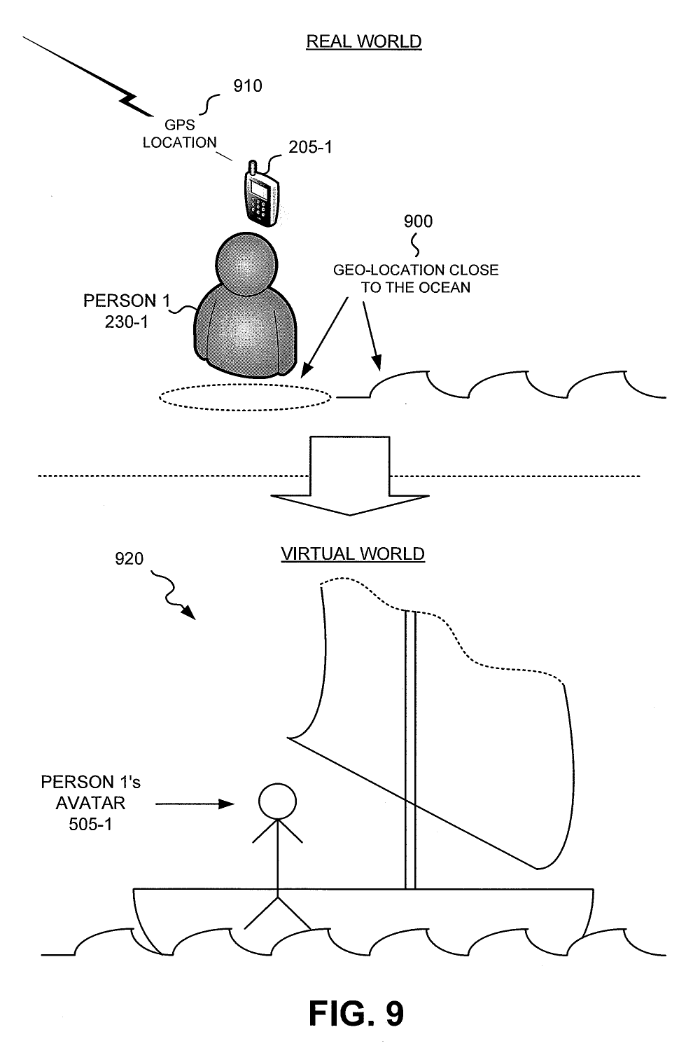

FIG. 9 depicts yet another example in which a person 230-1 has a current geo-location 900 in the real world close to the ocean as determined by GPS location data 910 from mobile wireless device 205-1. In the virtual world, the person's avatar 505-1 is displayed as engaging in sailing a sailboat 920 in a virtual ocean.

### CONCLUSION

The foregoing description of implementations provides illustration and description, but is not intended to be exhaustive or to limit the invention to the precise form disclosed. Modifications and variations are possible in light of the above teachings, or may be acquired from practice of the invention. For example, while series of blocks have been described with regard to FIG. 4, the order of the blocks may be modified in other implementations. Further, non-dependent blocks may be performed in parallel. Exemplary embodiments described herein may be implemented as an “add-on” feature to existing virtual worlds. Thus, for example, a participant in the virtual world can select whether the participant's avatar engages in activities in the virtual world based on existing mechanisms of the virtual world, or based on data associated with carrying and/or using a mobile wireless device owned by the participant. In other embodiments, the virtual world described herein may be implemented independently of existing virtual worlds. The virtual world has been described herein as being implemented at virtual world server 215 (e.g., an on-line virtual world that clients may log in to). In other embodiments, however, the virtual world may be implemented at a client application at one or more of clients 220-1 through 220-N.

In some embodiments, advertisements may be provided in the virtual world based on a person's real world activity. For example, if geo-location data indicates that a person often goes to a given cinema, current movies playing at that cinema may be shown on a billboard in the vicinity of the person's avatar in the virtual world. Additionally, discount coupons to that cinema may be provided to the person's avatar in the virtual world.

It will be apparent that aspects described herein may be implemented in many different forms of software, firmware, and hardware in the implementations illustrated in the figures. The actual software code or specialized control hardware used to implement these aspects is not limiting of the invention. Thus, the operation and behavior of the aspects have been described without reference to the specific software code, it being understood that software and control hardware could be designed to implement the aspects based on the description herein.

Even though particular combinations of features are recited in the claims and/or disclosed in the specification, these combinations are not intended to limit the invention. In fact, many of these features may be combined in ways not specifically recited in the claims and/or disclosed in the specification.

No element, act, or instruction used in the present application should be construed as critical or essential to the invention unless explicitly described as such. Also, as used herein, the article “a” is intended to include one or more items. Where only one item is intended, the term “one,” “single,” or similar language is used. Further, the phrase “based on” is intended to mean “based, at least in part, on” unless explicitly stated otherwise.

What is claimed is:

1. A computer-implemented method, comprising:
generating a virtual world;
generating a first avatar, that is associated with a person, in the virtual world;
receiving first data associated with the person's mobile wireless device, where the first data comprises a location of the mobile wireless device;
determining the person's real world activities based on the first data; and
causing the person's first avatar to engage in the same, similar, or analogous activities, as the determined real world activities, in the virtual world.

2. The computer-implemented method of claim 1, further comprising:
receiving second data associated with the person, where the second data relates to light conditions or ambient noise of an environment at which the person is located or a motion associated with the person; and
determining the person's real world activities further based on the second data.

3. The computer-implemented method of claim 1, where determining the person's real world activities comprises:
deducing the person's real world activities based on the first data.

4. The computer-implemented method of claim 1, where the first data further comprises a communication status associated with the mobile wireless device.

5. The computer-implemented method of claim 1, where the communication status comprises whether the person is communicating with another person using the mobile wireless device.

6. The computer-implemented method of claim 5, further comprising:
generating a second avatar associated with the other person in the virtual world; and
causing the other person's second avatar to interact with the first avatar in the virtual world based on the communication status.

7. The computer-implemented method of claim 5, where the person is communicating with the other person via an audio phone call.

8. The computer-implemented method of claim 5, where the person is communicating with the other person via instant messaging.

9. The computer-implemented method of claim 5, where the person is communicating with the other person via email.

10. The computer-implemented method of claim 5, where the person is communicating with the other person via text messaging.

11. A system, comprising:
a network interface configured to receive data associated with a person's mobile wireless device, where the data comprises a location of the mobile wireless device; and
one or more processing units configured to:
generate a virtual world,
deduce the person's real world activities based on the data, and
cause an avatar associated with the person to engage in the same, similar, or analogous activities, as the deduced real world activities, in the virtual world.

12. The system of claim 11, where the data further comprises a communication status associated with the mobile wireless device.

13. The system of claim 11, where the communication status comprises whether the person is communicating with an other person using the mobile wireless device.

14. The system of claim 13, the one or more processing units further configured to:
generate a second avatar associated with the other person in the virtual world, and
cause the other person's second avatar to interact with the first avatar in the virtual world based on the communication status.

15. The system of claim 13, where the person is communicating with the other person via an audio phone call.

16. The system of claim 13, where the person is communicating with the other person via instant messaging.

17. The system of claim 13, where the person is communicating with the other person via email.

18. The system of claim 13, where the person is communicating with the other person via text messaging.

19. A computer-readable medium containing instructions executable by at least one processor, the computer-readable medium comprising:
one or more instructions for generating a virtual world;
one or more instructions for receiving data associated with a location of a person's mobile wireless device;
one or more instructions for automatically engaging a first avatar associated with the person in activities in the virtual world based on the data.

20. The computer-readable medium of claim 19, where the data further comprises a communication status associated with the mobile wireless device.

21. The computer-readable medium of claim 19, where the communication status comprises whether the person is communicating with an other person using the mobile wireless device.

22. The computer-readable medium of claim 21, further comprising:
one or more instructions for automatically engaging a second avatar associated with the other person in activities in the virtual world based on the communication status.

23. A computer system, comprising:
means for generating a virtual world;
means for receiving data associated with a person's mobile wireless device, where the data comprises a location of the mobile wireless device and a communication status associated with the mobile wireless device;
means for determining the person's real world activities based on the data; and
means for causing an avatar associated with the person to engage in the same, similar, or analogous activities, as the determined real world activities, in the virtual world.
